(19) United States
(12) Patent Application Publication
(10) Pub. No.: US 2003/0006121 A1
(43) Pub. Date: Jan. 9, 2003

(54) Passive radio frequency identification system for identifying and tracking currency

(76) Inventors: Kenneth Yukou Lee, Dayton, NJ (US); Joseph R. Stencel, Skillman, NJ (US); Yook-Kong Yong, Princeton, NJ (US)

Correspondence Address: Joseph R. Stencel, 70 Meadow Run Dr., Skillman, NJ, 08558, US

(21) Appl. No.: 09/900,604

(22) Filed: Jul. 9, 2001

(51) Int. Cl. G07F 7/04

(52) U.S. Cl. 194/206

(57) ABSTRACT

A new passive radio frequency identification (RFID) system to authenticate, identify, and sum currency amounts is described. The inventive device includes (1) a paper-like passive RFID transponder which could be embedded in a currency or used as the currency itself, and which contains encrypted/non-encrypted electronic bits of data (serial number, currency amounts, etc.) to uniquely identify said currency, (2) a transceiver for wireless interrogation of the transponder, (3) a computer server and/or database management system that is used for currency authentication to a known currency information database. The passive RFID transponder is paper-like, robust, and could be printed as a currency, or embedded in a currency. The transceiver sends an electromagnetic signal, which is picked up by the passive transponder in the currency. The passive RFID transponder in said currency uses the energy of the electromagnetic signal via electromagnetic coupling (backscatter) to transmit its serial number, currency denomination, and other desired encrypted/non-encrypted information back to the transceiver.

### BACKGROUND OF THE INVENTION

1. Field of the Invention

The present invention relates to a paper-like passive radio frequency identification transponder which could be embedded in a currency or printed as the currency itself and used with a wireless radio frequency identification (RFID) system to identify, count, and authenticate the said currency for various applications such as automated currency counting and authentication in cash registers or currency storages, counterfeit currency detection (crime prevention/deterrence), and detection and counting of the said currency on persons at immigration customs or at financial or government institution entrances/exits. Other uses include gift certificates, checks, travelers checks, stock certificates, bond certificates, money orders, or other items which are used as a currency.

2. Description of the Prior Art

The only known prior art for this type of an invention is U.S. Pat. No. 6,131,718. While this device fulfills its respective, particular objectives and requirements for the detection of counterfeit currency, the aforementioned patent does not disclose a new system for identifying currency using a passive radio frequency identification system. Our new inventive system includes uniquely identifying each individual currency without having to scan it individually and then using a data management system to sum the value of the currency, and to authenticate the said currency using a remote/local currency information database.

### SUMMARY OF THE INVENTION

In view of the disadvantages and limitations inherent in screening/authentication processes used for financial transactions and identification, the present invention will offer a quick screening/authentication process for identifying the denomination, number, and total sum of currency without having to directly view the currency.

The general purpose of the present invention, which will be described subsequently in greater detail, is to substantially enhance the accuracy and screening of currency.

The list below provides the objectives of the present invention:

1. To embed a paper-like passive RFID transponder in a currency or use the paper-like passive RFID transponder as the currency itself which will identify the denomination, serial number, and any other desired encrypted/non-encrypted information by the currency issuer. A wireless transceiver is used to interrogate the transponder and a computer is used to analyze the information received by the transceiver.

2. To provide a real-time screening method in places like immigration customs, banks and other financial/government institution checkpoints, cash registers, and currency storages; to sum up currency amounts, identify and authenticate its origin, and thereby having an ability to search for counterfeits and other currency anomalies.

3. To provide greater security and control over currency productions by supplying a method to track currencies, and to prevent or authenticate forgeries.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic drawing of a paper-like passive radio frequency identification (RFID) transponder which is embedded in a currency, or is the currency itself, such as a U.S. dollar bill.

FIG. 2 is a schematic drawing of the electromagnetic coupling (backscatter) of the transceiver and the passive RFID transponder.

FIG. 3 is a schematic drawing of the invention used at an immigration custom checkpoint for real-time identification, authentication, and calculation of the amount of currency held by an individual.

FIG. 4 is a schematic drawing of the invention used at a banking institution for real-time identification, authentication, and calculation of the amount of currency within the bank vault.

FIG. 5 is schematic drawing of the invention used for real-time identification, authentication, and calculation of the amount of currency within an individual cash register.

### DESCRIPTION OF THE PREFERRED EMBODIMENTS

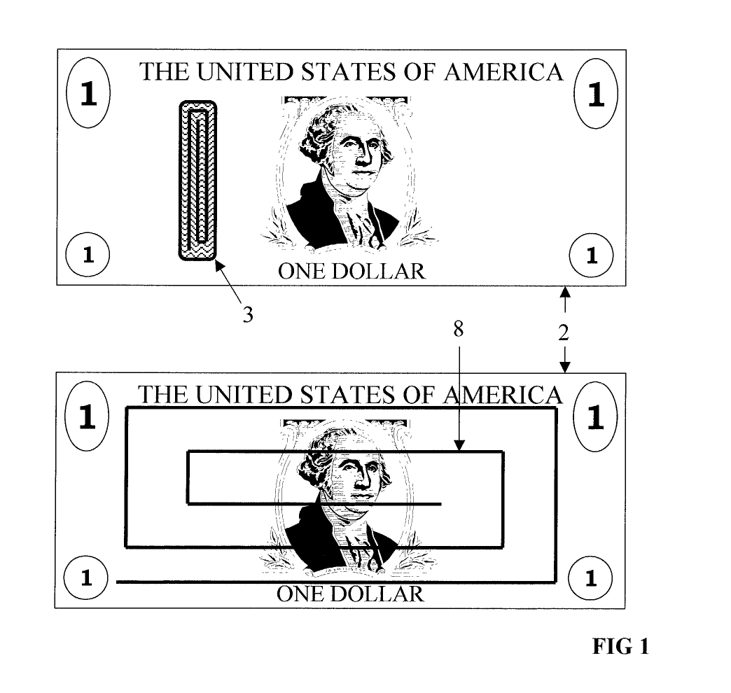

With reference now to the drawings, and in particular to FIGS. 1 through 5 thereof, a new paper-like passive radio frequency identification (RFID) system for identifying and summing currency amounts and embodying the principles and concepts of the present invention and generally designated by the reference numeral 1 will be described.

More specifically, it will be noted that the present invention 1 comprises a passive RFID transponder 3 containing encrypted/non-encrypted electronic bits of data (serial number, currency value, and any other desired information) embedded within currency 2 or a passive RFID transponder 8 as the currency 2 itself, a wireless transceiver 4 to read the serial number, currency value, and any other identifying characteristics desired of the passive RFID transponder 3, a computer server 6 and/or database management system 7 to maintain a database for tracking and comparing the currency data for summing total amounts of currency, authenticate currency for counterfeit detection if desired, for banking transactions, business transactions, etc. Identification can also be a hand held personal data assistant (PDA) to transmit and receive information at a local or remote setting where a database management system is not available.

As shown in FIG. 1, the passive RFID transponder 3 or 8 from the currency 2 will transmit its serial number, currency value, and other encrypted/non-encrypted data when interrogated by a transceiver 4. The passive RFID transponder is paper-like, robust, and could be printed as a currency or embedded in a currency by the issuer.

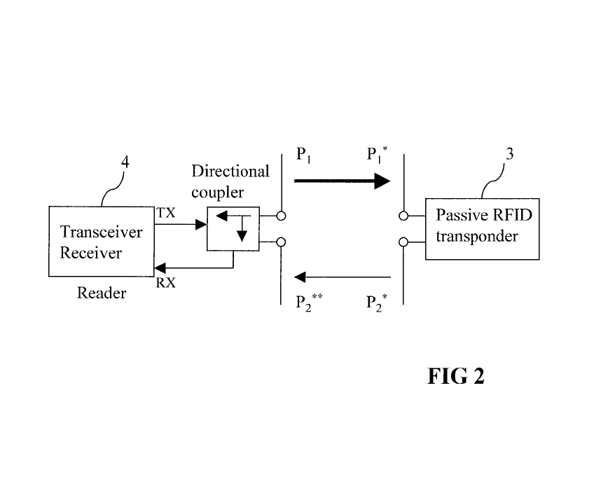

FIG. 2 shows operating principles of a transceiver 4 and the passive RFID transponder 3. The transceiver 4 transmits an electromagnetic signal with a power P₁ to the transponder 3. The transponder 3 electromagnetically couples by resonance to the arriving signal and uses the energy of this arriving signal to do work. The arriving signal has a reduced power P₁* due to attenuation and scattering. The transponder 3 transponds to the arriving signal and its power by transmitting its serial number and/or other encrypted/non-encrypted data with a further reduced power P₂* back to the transceiver 4. The transponder signal arrives at the transmitter with a power P₂**. Due to attenuation and scattering, the power P₂** is further reduced, and hence the communication between the transceiver 4 and transponder 3 would have a range depending on transmitting power.

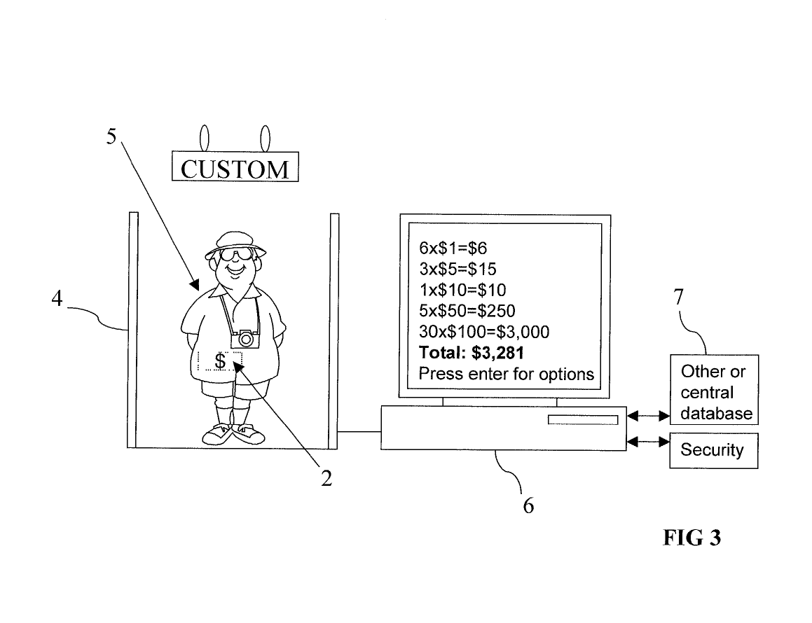

FIG. 3 shows an immigration custom check point where the currency 2 carried by an individual 5 is scanned by transceiver 4. The mechanism is the same as FIG. 2 for the transmittal of information. It should be noted that a computer 6 is used to process the information received by the transceiver 4. A suitcase or any other type of baggage could also be easily scanned at a checkpoint. Besides giving the amount of currency, if the system is hooked into a central data base management system 7, an immediate feedback will be available on the legitimacy of the currency. The computer 6 can also be connected to alert security personnel or police if currency anomaly is detected.

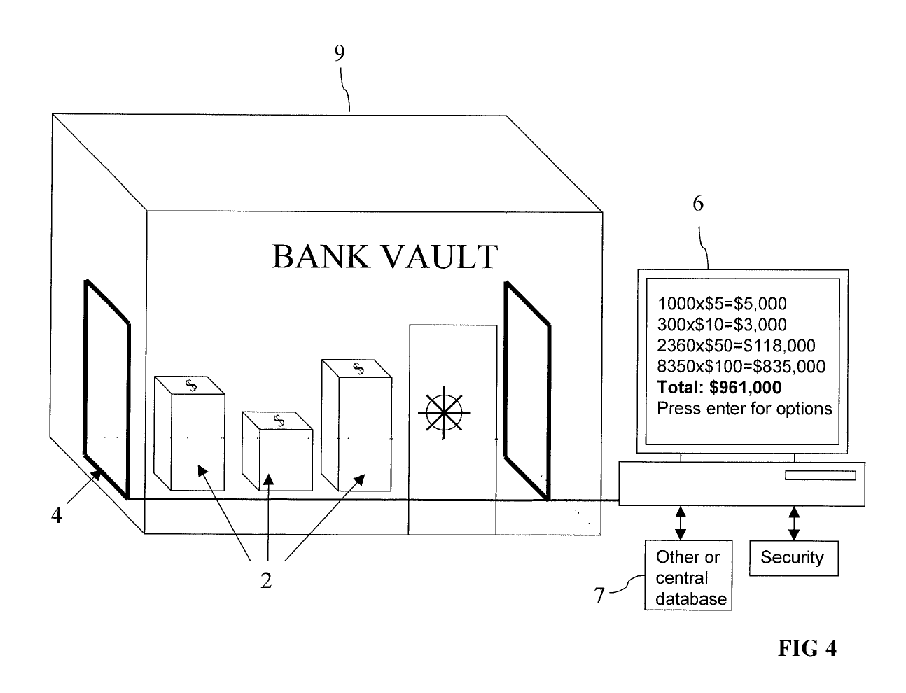

FIG. 4 indicates a system similar to FIGS. 2 and 3, but for keeping an accurate and real-time count of the amount of currency 2 within a bank vault 9. Again the mechanism is the same for the transfer of information as noted in the previous two figures. A wireless transceiver 4 reads the information on the currency 2 and sends the information to a computer 6 for analysis. In addition, the financial institution can use the system for summing of currency during a customer transaction thereby reducing errors and person-hours in reviewing and authenticating the currency.

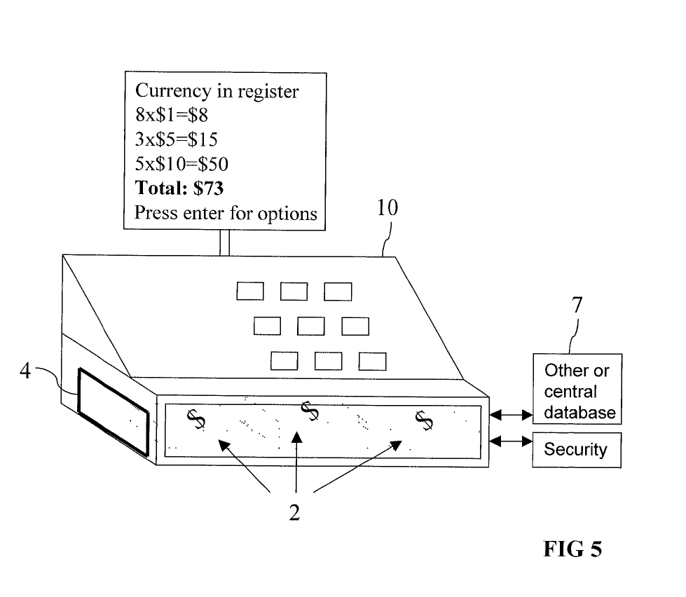

FIG. 5 shows a situation similar to the previous figures where an individual cash register 10 will have the ability to authenticate and keep an accurate and real-time record of the currency 2. This will aid in tracking of financial data, peak hours of sales, when to retrieve currency, theft prevention, reduce currency transaction errors, etc.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. a system for real-time authentication, identification, and summation of currency comprised of a paper-like passive RFID transponder that can be embedded anywhere within a currency or be employed as the currency itself, and a transceiver for wireless interrogation of the transponder;

2. a real-time currency scan method to sum currency amounts and to authenticate currency;

3. a database management system for comparing currency to a known currency informational database to authenticate currency, track lost currency, and to identify counterfeits;

4. a system for real-time authentication, identification, and summation of currency held by an individual at a checkpoint, for example, at immigration customs, financial or government institution entrances/exits, etc., without having to physically locate or count the currency;

5. a real-time accounting and authentication of currency in cash registers or other currency storages to aid in tasks such as cash removal periods, peak sales volume periods, reduction in currency transaction errors, and identification and prevention of counterfeits.
